(19) United States
(12) Patent Application Publication
(10) Pub. No.: US 2022/0386143 A1
(43) Pub. Date: Dec. 1, 2022

(54) METHOD AND BASE STATION FOR COMMUNICATION IN A HIGH FREQUENCY NETWORK

(71) Applicant: Samsung Electronics Co., Ltd., Suwon-si (KR)

(72) Inventors: Anusha GUNTURU, Bangalore (IN); Ashok Kumar Reddy CHAVVA, Bangalore (IN); Divpreet SINGH, Bangalore (IN); Ankur GOYAL, Bangalore (IN); Ashok Kumar SAHOO, Bangalore (IN)

(21) Appl. No.: 17/825,555

(22) Filed: May 26, 2022

Related U.S. Application Data
(63) Continuation of application No. PCT/KR2022/007491, filed on May 26, 2022.

(30) Foreign Application Priority Data
May 27, 2021 (IN) 202141023706
May 6, 2022 (IN) 2021 41023706

(51) Int. Cl. H04W 16/28; H04W 52/24; H04W 52/36; H04W 74/08; H04W 56/00

(52) U.S. Cl. CPC H04W 16/28; H04W 52/242; H04W 52/36; H04W 74/0833; H04W 56/001

(57) ABSTRACT

The disclosure refers to a method and a base station for communication in a high frequency network are provided. The method includes generating a first beam having a first beamwidth in a first area of a cell, determining a plurality of second beamwidth levels for a plurality of second beams possible in the first beamwidth of the first beam, wherein a second beamwidth associated with each of the plurality of second beams is narrower than the first beamwidth, generating the plurality of second beams having the plurality of determined second beamwidth levels, and transmitting at least one synchronization message to a plurality of user equipments via the first beam and the plurality of second beams.

### CROSS-REFERENCE TO RELATED APPLICATION(S)

This application is a continuation application, claiming priority under § 365(c), of an International application No. PCT/KR2022/007491, filed on May 26, 2022, which is based on and claims the benefit of an Indian Provisional patent application number 202141023706, filed on May 27, 2021, in the Indian Intellectual Property Office, and of an Indian Complete patent application number 202141023706, filed on May 6, 2022, in the Indian Intellectual Property Office, the disclosure of each of which is incorporated by reference in herein in its entirety.

### FIELD OF THE INVENTION

The disclosure relates to a method and a base station for communication in a high frequency network.

### BACKGROUND

Terahertz (THz) communication frequency ranges from 0.1 THz to 10 THz. The THz communication has abundant usable bandwidth of tens of Gigahertz (GHz) compared to GHz available below 200 GHz frequency or mmWave and sub-6 GHz. As THz bands provide ultra-wide bandwidth, there are several applications areas which require high data rates above tens of Gbps that can be provided in these bands, such as, nanoscale and macro-scale communications utilization.

FIG. 1 illustrates a graphical representation of path loss in THz communication, according to the related art.

However, current techniques to use THz frequency range suffer from path loss. The path loss in the THz frequency range comprises both spreading and the absorption losses. As shown in FIG. 1, THz experiences absorption noise unlike mmWave, which becomes severe at certain frequencies causing spikes in the observed path loss and also becomes significant with increasing distance.

Further, as the THz communication operates in high frequency range and suffers path loss, highly directive antennas and massive antenna array techniques are required in THz to compensate for the absorption losses and to enhance the outdoor coverage. Also, with smaller wavelengths compared to mmWave, for example, in the range of 3 mm to 30 μm, antenna sizes can go down to miniature size supporting nano devices as well. Along with nano devices, massive antenna arrays can be made feasible in the commercially deployed user equipment (UE) as well with small size antennas supporting narrower and energy efficient beamwidths compared to mmWave. However, with narrower beams, the number of beams at the transmitter and receiver are increased, which makes an exhaustive list of beams for searching, alignment and pairing between transmit and receiver beams.

Further, beamwidths in THz can be very narrow and energy efficient because of the increased number of antennas, possible to incorporate in THz systems. However, with narrower beam widths, the number of beams required to cover specific area is quite high, making it an exhaustive list of beams for refinement and management procedures.

In addition, the alignment of beams at the transmitter and receiver becomes very difficult because of the reduced beam width. This alignment problem becomes severe in cases of user mobility and the orientation changes. Also, severe path loss is observed at certain frequencies with increasing distance in THz frequency range. Hence, users at different distances shall be allocated resources carefully by avoiding the high path loss frequencies.

Also, as distance dependent path loss severity is observed in THz, procedures for THz need to be distance aware unlike the procedures in the existing lower frequency systems.

However, there does not exist any technique which attempts to solve the above-mentioned problems. Hence, there is a need to provide techniques which overcome the above discussed problems in the art.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and a system for communication in a high frequency network base station.

Additional aspects will be set forth in part in the description which follows and, in part, will be apparent from the description, or may be learned by practice of the presented embodiments.

In accordance with an aspect of the disclosure, a method for communication by a base station in a high frequency network is provided. The method includes generating a first beam having a first beamwidth in a first area of a cell, determining a plurality of second beamwidth levels for a plurality of second beams possible in the first beamwidth of the first beam, wherein a second beamwidth associated with each of the plurality of second beams is narrower than the first beamwidth, generating the plurality of second beams having the determined plurality of second beamwidth levels, and transmitting at least one synchronization message to a plurality of user equipments via the first beam and the plurality of second beams.

In accordance with another aspect of the disclosure, a base station for communication in a high frequency network is provided. The base station includes a memory and a processor coupled to the memory. The processor is configured to generate a first beam having a first beamwidth in a first area of a cell, determine a plurality of second beamwidth levels for a plurality of second beams possible in the first beamwidth of the first beam, wherein a second beamwidth associated with each of the plurality of second beams is narrower than the first beamwidth, generate the plurality of second beams having the determined plurality of second beamwidth levels, and transmit at least one synchronization message to a plurality of user equipment via the first beam and the plurality of second beams.

To further clarify the advantages and features of the disclosure, a more particular description of the disclosure will be rendered by reference to specific embodiments thereof, which is illustrated in the appended drawing. It is appreciated that these drawings depict only typical embodiments of the disclosure and are therefore not to be considered limiting its scope. The disclosure will be described and explained with additional specificity and detail with the accompanying drawings.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a graphical representation of path loss in THz communication, according to the related art;

FIG. 2 illustrates a flow diagram depicting a method for communication in a high frequency network base station, according to an embodiment of the disclosure;

FIG. 3 illustrates multiplexing of the first beam and second beams in frequency domain, according to an embodiment of the disclosure;

FIG. 4 illustrates multiplexing of the first beam and second beams in time domain, according to an embodiment of the disclosure;

FIG. 5 illustrates multiplexing of the first beam and second beams in time domain, according to an embodiment of the disclosure;

FIG. 6 illustrates hierarchical beam sequencing, according to an embodiment of the disclosure;

FIGS. 7A and 7B illustrate pictorial representation of combining beams of different beamwidths, according to various embodiments of the disclosure;

FIG. 8 illustrates transmission of synchronization signal block (SSB) with first beam and second beams, according to an embodiment of the disclosure;

FIGS. 9A and 9B illustrate initial acquisition with suitable SSB beam widths, according to various embodiments of the disclosure;

FIG. 10 illustrates a flow chart depicting a process for initial random access channel (RACH) procedure in THz, according to an embodiment of the disclosure;

FIG. 11 illustrates a graphical representation of path loss at certain frequencies with increasing distance in THZ, according to an embodiment of the disclosure;

FIG. 12 illustrates a flow chart depicting a process for resource allocation in THz, according to an embodiment of the disclosure;

FIG. 13 illustrates a flow chart depicting a process for resource allocation in THz, according to an embodiment of the disclosure;

FIG. 14 illustrates a flow chart depicting a process for resource allocation in THz, according to an embodiment of the disclosure;

FIG. 15 illustrates a flow chart depicting a process for beam failure recovery in THz, according to an embodiment of the disclosure; and

FIG. 16 illustrates a block diagram of a system communication in a high frequency network base station, according to an embodiment of the disclosure.

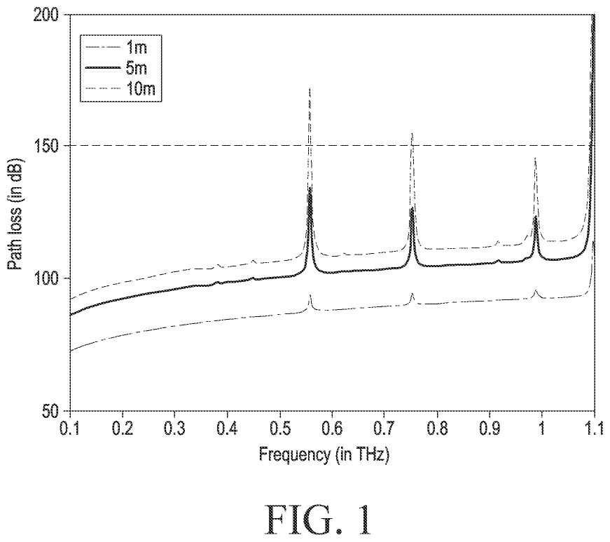

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be understood at the outset that although illustrative implementations of the embodiments of the disclosure are illustrated below, the disclosure may be implemented using any number of techniques, whether currently known or in existence. The disclosure should in no way be limited to the illustrative implementations, drawings, and techniques illustrated below, including the design and implementation illustrated and described herein, but may be modified within the scope of the appended claims along with their full scope of equivalents.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes,” “comprises,” “has,” “consists,” and grammatical variants thereof do NOT specify an exact limitation or restriction and certainly do NOT exclude the possible addition of one or more features or elements, unless otherwise stated, and furthermore must NOT be taken to exclude the possible removal of one or more of the listed features and elements, unless otherwise stated with the limiting language “MUST comprise” or “NEEDS TO include.”

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more . . . ” or “one or more element is REQUIRED.”

Unless otherwise defined, all terms, and especially any technical and/or scientific terms, used herein may be taken to have the same meaning as commonly understood by one having an ordinary skill in the art.

It should be noted that the term user equipment (UE) refers to any electronic device used by a user such as a mobile device, a desktop, a laptop, personal digital assistant (PDA) or other similar communication devices.

It should be noted that the terms UE and receiver have been interchangeably used throughout this disclosure.

It should be noted that although the techniques have been discussed in respect of sixth generation (6G) terahertz THz, the disclosed techniques may also be used in other higher frequency networks.

It should be noted that the terms synchronization signal block (SSB) and synchronization message have been interchangeably used throughout this disclosure.

The disclosure is directed towards introducing flexible bandwidth and center frequency allocation introduced in THz to support different types of users. The disclosure proposes that SSBs with different beamwidths be transmitted to support users at different distances in THz cell. Also, SSBs with different beamwidths can be multiplexed in time domain or frequency domain.

Embodiments of the disclosure will be described below in detail with reference to the accompanying drawings.

Receivers at different distances experience significantly varying path loss at a certain frequency in THz. Hence, the synchronization signals along with the broadcast information, SSBs transmitted with single beam width may not be useful or ideal for the users at different distances in a cell. To solve this problem, in an embodiment, the disclosure proposes a hierarchical beam width based initial acquisition for THz communications in which the SSBs with different beamwidths can be transmitted by the base station with varying or same periodicities, and the users can try to perform the acquisition in a hierarchical fashion.

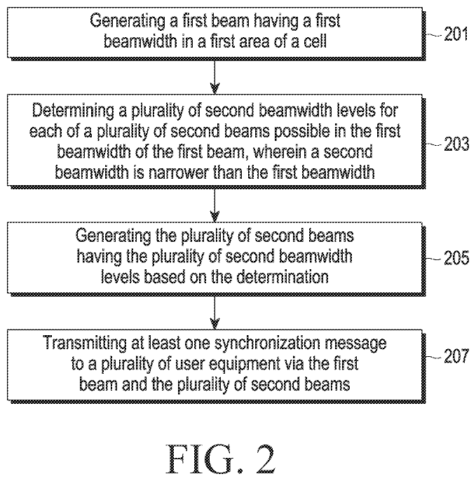

FIG. 2 illustrates a flow diagram depicting a method for communication in a high frequency network base station (BS), according to an embodiment of the disclosure. In particular, a method for communication between a high frequency network base station and a plurality of user equipment (UE) has been discussed below.

Referring to FIG. 2 at operation 201, the method 200 comprises generating a first beam having a first beamwidth in a first area of a cell. For example, let us consider that a base station provides coverage to a cell C1 and the cell is covered by a plurality of areas A1-An. Accordingly, a first beam with beamwidth θ₁ is generated in A1. It is to be noted that the first beamwidth can be considered as beamwidth which is required for maximum coverage in the first area of the cell. In an embodiment, let us consider that a 60 degrees beamwidth is required to provide maximum coverage in A1. Accordingly, the first beamwidth is 60 degrees. It is to be noted that only an example of beamwidth has been provided and the value of beamwidth may vary according to implementation of the base station. Further, it is to be noted that the first area, i.e., A1 may be first determined and then the first beam may be generated.

Thereafter, at operation 203, the method 200 comprises determining a plurality of second beamwidth levels for each of a plurality of second beams possible within the first beamwidth of the first beam. The first beamwidth may be divided into a plurality of second beamwidths and each of the second beamwidth is narrower than the first beamwidth. For example, the first beam of beamwidth of 60 degree may be divided into 4 beamwidths of 15 degrees. In another example, the first beam of beamwidth of 60 degree may be divided into 2 beamwidths of 20 degrees and 2 beamwidths of 10 degrees. Accordingly, beamwidth level for each of the second possible beam is determined.

Then, at operation 205, the method 200 comprises generating the plurality of second beams having the plurality of second beamwidth levels based on the determination. In an embodiment, the second beamwidth may be represented by θ₂

Thereafter, at operation 207, the method 200 comprises transmitting at least one synchronization message to a plurality of user equipment via the first beam and the plurality of second beams. In particular, the synchronization message may be transmitted using the first beam and the second beams. It is to be noted that the synchronization message may be associated with a synchronization signal block (SSB).

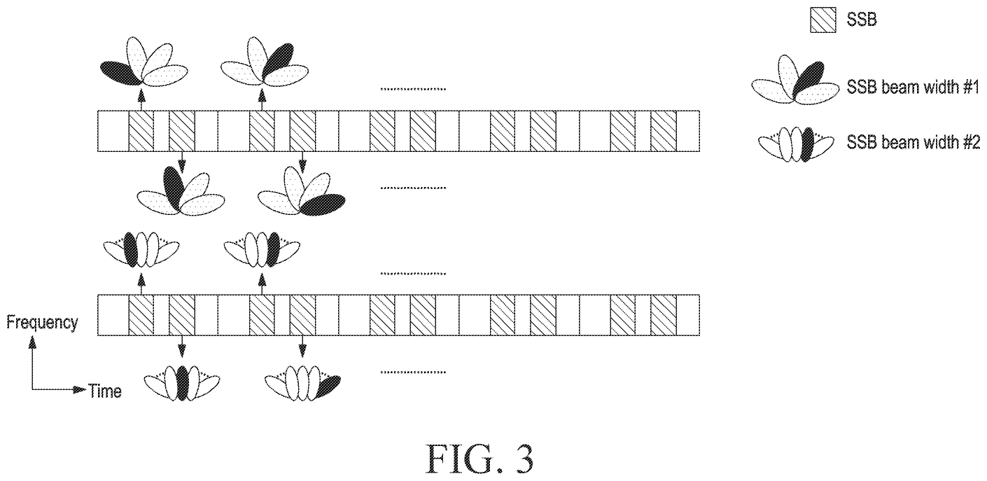

In an embodiment, the different beamwidths, i.e., the first beam and the second beams may be multiplexed either in time domain or frequency domain, to transmit the synchronization message. FIG. 3 illustrates multiplexing of the first beam and second beams in frequency domain, according to an embodiment of the disclosure. Referring to FIG. 3, a first beam with a first beamwidth and a plurality of second beams are transmitted with a second beamwidth in different frequency levels but in a same time slot. These frequency levels can be similar to the 3^{rd} generation partnership project (3GPP) specification defined synchronization raster steps for new radio (NR) radio access technology (RAT). Hence, the first beam and the second beam are transmitted periodically. It is to be noted that these different beams may be transmitted in different bandwidth parts as well. So, the base station can use different beamwidths simultaneously and the UE can detect the base station on any beamwidth suitable to it.

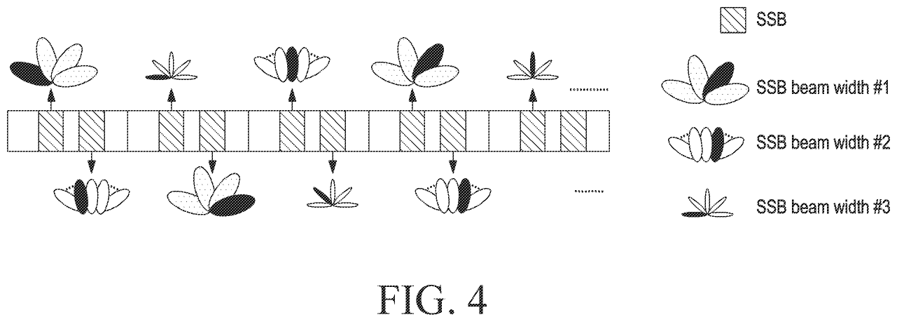

FIG. 4 illustrates multiplexing of the first beam and second beams in time domain, according to an embodiment of the disclosure. Referring to FIG. 4, a first and plurality of second beams with different beamwidths but a same SSB are transmitted consecutively one after the other and then the transmission is repeated once one set of the beams with all types of beamwidths is transmitted. Here the number of beams per beamwidth is same as the number of SSBs. Hence, all the beamwidths are transmitted with same periodicity.

However, this may not be suitable for the case when the number of beams with certain beam width differ from that of the other beam width.

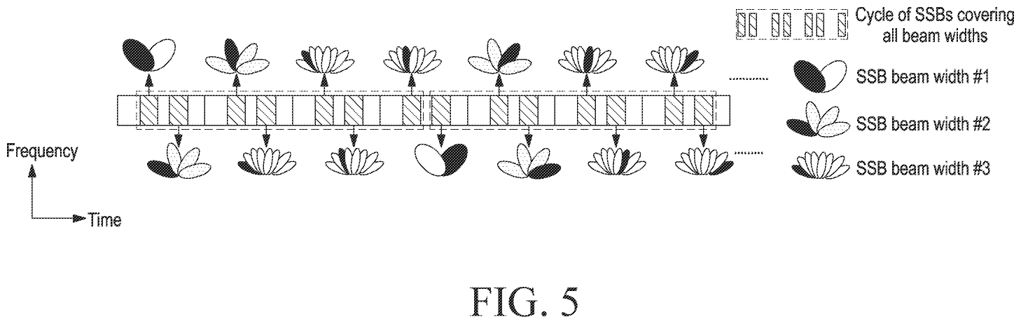

FIG. 5 illustrates multiplexing of the first beam and second beams in time domain, according to an embodiment of the disclosure. The number of beams possible within each beam width can be different such that all types of beamwidths can cover the area A1 of cell C1. For example, if N₁, N₂ and N₃ represent the number of beams with beamwidths θ₁, θ₂, and θ₃, respectively, such that θ₁>θ₂>θ₃, then the number of beams for these beamwidths follow the order of N₁<N₂<N₃. The multiplexing sequence is decided by the BS. FIG. 5 shows an example of this multiplexing sequence with N₁=2, N₂=4 and N₃=8. The number of beams for a given beamwidth may or may not be a multiple of the number of beams with largest beamwidth.

In another embodiment, the SSBs transmitted within one cycle (one cycle covers the SSBs with different beam widths) can be transmitted from same set of antennas such that at least one UE can combine the signals at the receiver for better reception. In other words, the SSBs transmitted within one cycle can be transmitted with same transmit antenna set (but with different beamwidths by selecting specific set for each beam width) indicating that the at least one UE can use the receiver beam in same direction for receiving these SSBs within one cycle. Hence, sequencing of the first beam and the plurality of second beams is done such that the first beam and at least one of the plurality of second beams in same direction are multiplexed consecutively in the time domain.

Further, the base station may receive a response to the at least one synchronization message from the at least one UE, amongst the plurality of user equipment, over one of the first beam and the plurality of second beams. In response to this reception, the base station may establish a connection with the at least one UE over one of the first beam and the plurality of second beams. In other words, if the base station receives the response over the first beam, then the base station establishes the connection with the UE over the first beam. On the other hand, if the base station receives the response over the plurality of second beams, then the base station establishes the connection with the UE over the plurality of second beams.

In an embodiment, the at least one synchronization message may be transmitted via the first beam and the plurality of second beams during initial access procedure. It is to be noted that for the THz system, the number of beams is higher compared to fifth generation (5G) New radio (NR) system. Hence, for initial acquisition in THz system, the number of beams required to monitor and identify the cell may be high because of multiple beamwidths. However, once the initial acquisition is done, the THz base station can choose to allow the beams with different beamwidths in only required directions for the user data transmission in the connected mode.

Further, it can be noted that the above discussed method may be referred to as “Hierarchical Beam Sequencing.”

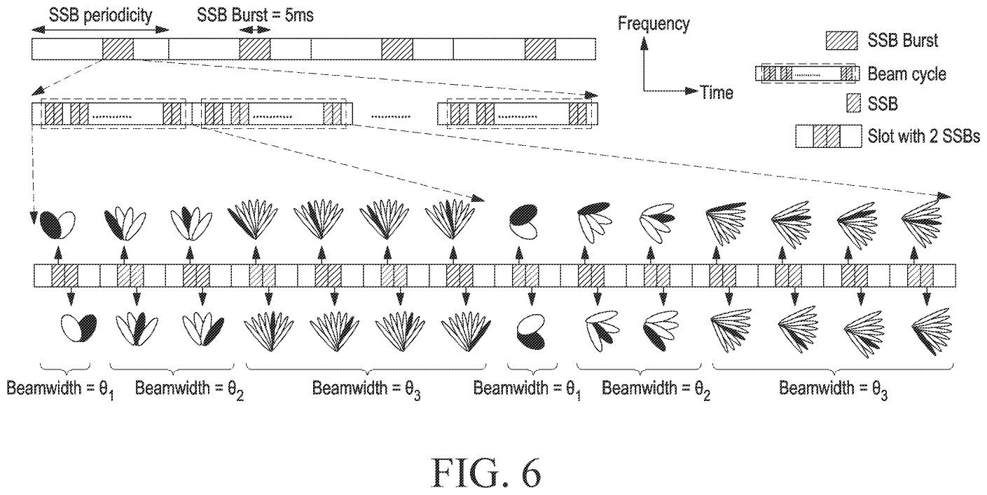

FIG. 6 illustrates hierarchical beam sequencing, according to an embodiment of the disclosure. It is to be noted that, the sequencing of beams in THz system is done such that one SSB burst consists of multiple beam cycles, where each cycle has the beams of different beamwidths as shown in FIG. 6, where 3 beamwidth levels are considered. In a beam cycle, every beam set corresponding to a beamwidth level covers the same sector area. Further, in an embodiment, the hierarchical beams of different beamwidth may be combined with each other.

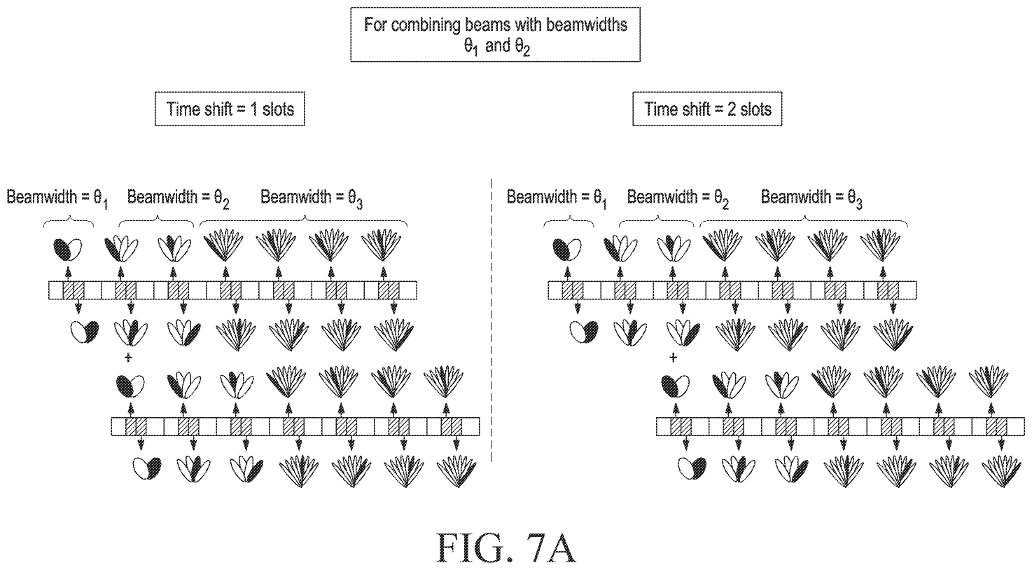

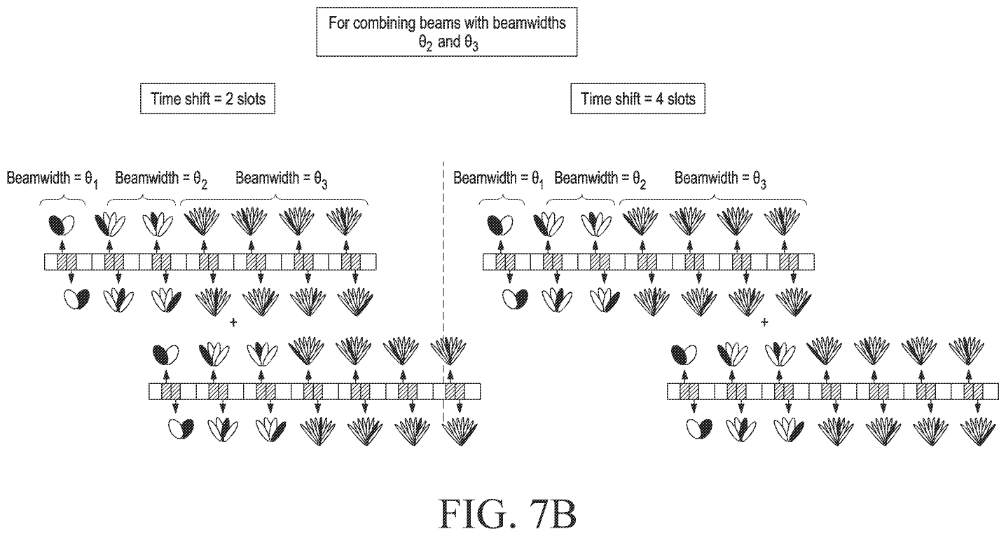

FIGS. 7A and 7B illustrate pictorial representation of combining beams of different beamwidth, according to various embodiment of the disclosure. In an embodiment, beams of a certain beamwidth are sequenced such that, when the received waveform is shifted in time in time units of slots, then the corresponding beams in same direction shall get combined as shown in FIGS. 7A and 7B. In particular, the UE can store the signals received during a burst and combine with appropriate time shifts. This combination helps in reducing the random noise and increasing the signal strength.

In an embodiment, for combining beams of beamwidths θ₁ and θ₂, time shifts of 1 slot and 2 slots will make sure of combining all the beams in same direction, as shown in FIG. 7A Similarly, for combining beams of beamwidths θ₂ and θ₃, time shifts of 2 slot and 4 slots will make sure of combining all the beams in same direction, as shown in FIG. 7B.

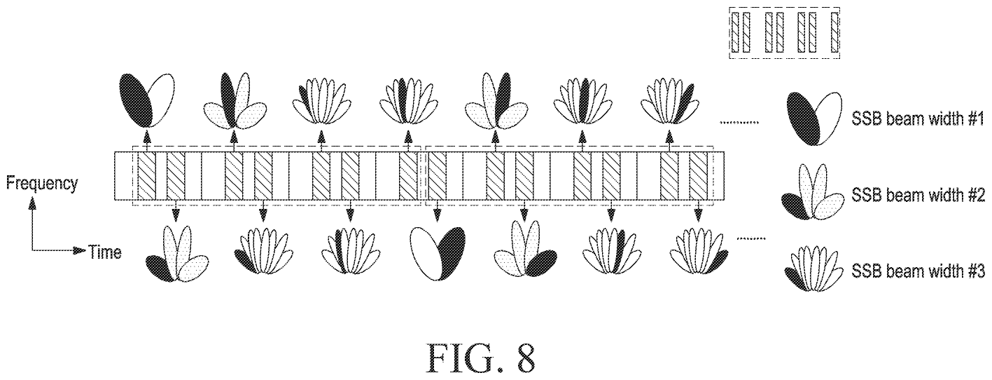

FIG. 8 illustrates transmission of synchronization signal block (SSB) with a first beam and second beams, in accordance with according to an embodiment of the disclosure.

In an embodiment, sequencing of different beam width level synchronization signals may be indicated through a Radio Resource Control (RRC) Reconfiguration message. Further, default periodicity to transmit the beams with different beamwidth may be fixed to minimum level and the sequencing to include all the beam width levels, as shown in FIG. 8. Further, periodicity of each cycle of the synchronization signals may be indicated through RRC Reconfiguration message.

Once the initial acquisition is done, sequencing can be altered and allowing or disabling a beam width level can be indicated to the user through RRC Reconfiguration message based on the user distance.

In another embodiment, transmission of at least one synchronization message via the first beam and the plurality of second beams may be allowed or disabled using a bit map and the allowed or disabled state may be indicated to the receiver through higher layer, RRC reconfiguration message, Physical Downlink Control Channel (PDCCH), or Medium Access Control (MAC) Control Element (MAC CE).

In a further embodiment, transmit power of the beam with one of the beamwidths and the offsets for other beamwidth levels may be indicated through either broadcast message, Master Information Block (MIB) or the RRC reconfiguration message.

In another embodiment, transmit powers for all the beamwidth levels may be indicated through either broadcast message, MIB or the RRC reconfiguration message.

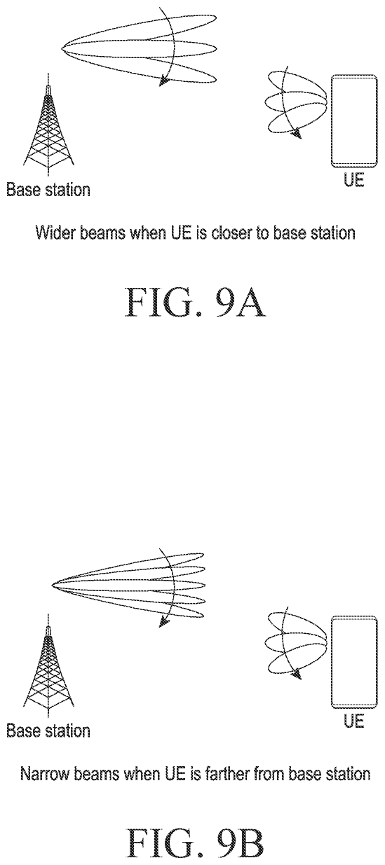

FIGS. 9A and 9B illustrate initial acquisition with suitable SSB beam widths, according to various embodiments of the disclosure.

SSBs with different beamwidths can be supported for THz where users at different distances can perform initial acquisition with suitable SSB beam widths, as shown in the FIGS. 9A and 9B. In an embodiment, to perform initial acquisition, the base station can indicate random access channel (RACH) resources to the UE through either RRC Re-configuration message or SIB1. While indicating the RACH resources, base station can map each RACH occasion with one or more SSBs so that the base station's receiving beam can be used in that direction of SSB for receiving the RACH messages. If the SSBs of different beamwidths are transmitted using method of FIG. 7B, RACH occasions can be mapped to multiple SSBs that are transmitted using elements chosen from same set of antenna elements at the base station. In other words, a plurality of SSBs with different first and second beamwidths may be associated in the same direction to the same RACH occasions when the plurality of SSBs are associated with single RACH occasion.

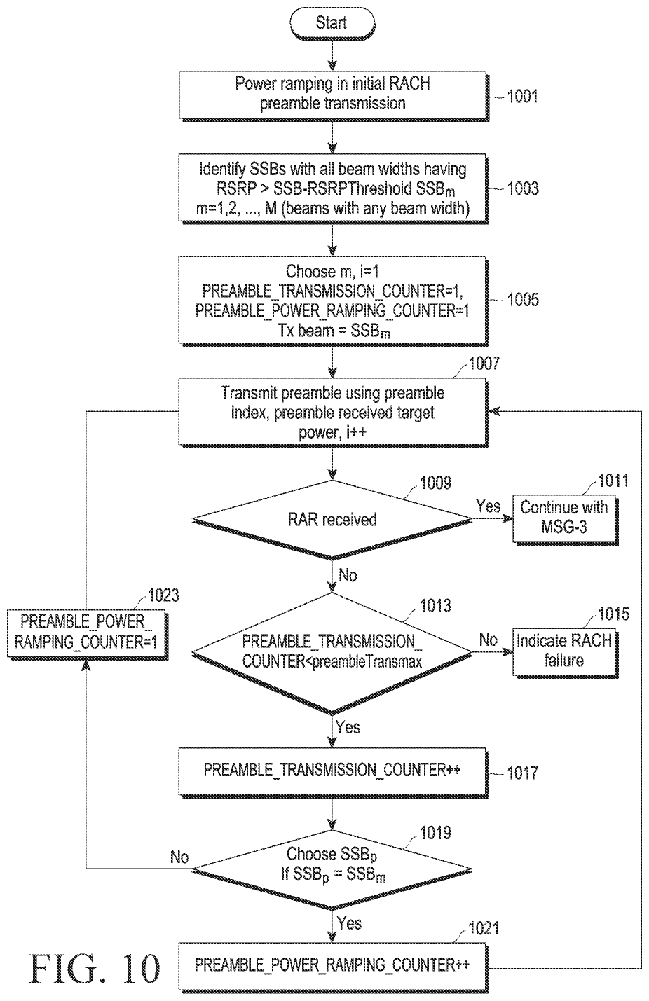

FIG. 10 illustrates a flow chart depicting a process for initial RACH procedure in THz, according to an embodiment of the disclosure. In an embodiment, the base station may generate the first beam and the second beam in accordance with techniques described in FIG. 2. Further, it is to be noted that the UE is one of the plurality of UEs to whom base station transmitted in operation 207. Referring to FIG. 10, at operation 1001, the UE performs power ramping in initial RACH preamble transmission. Then, at operation 1003, SSBs are identified whose reference signal received power (RSRP) crosses the required threshold of SSB-RSRP Threshold, i.e., a predetermined threshold. Hence, the base station may receive RACH preambles on RACH occasions corresponding to the second beamwidth level when at least one of synchronization message (SSB) is above the predetermined threshold. In an embodiment, the predetermined threshold is configurable and may vary from one base station to another. However, if multiple SSBs cross the threshold, then the UE can prefer to choose the SSBs in a hierarchical fashion in the order of decreasing beam width. Then, at operation 1005, preamble power ramping counter (PREAMBLE_POWER_RAMPING_COUNTER) and the preamble transmission counter (PREAMBLE_TRANSMISSION_COUNTER) are set to 1. At operation 1007, the UE can start transmitting the preamble with preamble power ramping counter and preamble transmission counter set to 1. Also, the UE may increment the power ramping and transmission counters by 1 in case the SSB chosen for preamble transmission doesn't change. The same can be applied for SSBs with different beam widths. At operation 1009, it is checked if Random Access Response (RAR) is received. It should be noted that RACH is a four operation process. These four operations include:

Msg1: Random Access Preamble (RA)

Msg2: Random Access Response (RAR)

Msg3: RRC Connection Request

Msg4: Contention Resolution

If RAR is received, then, at operation 1011, msg3, i.e., RRC connection request is sent by the UE In particular, after msg2 (from the base station to the UE) is detected by UE then with the same power as msg1, msg3 is sent by the UE. No power ramping/retransmission is needed here. After this, the UE waits for msg4 which is confirmation from the base station and end of RACH process. If no, then at operation 1013, it is checked if the preamble transmission counter is less than preamble maximum transmission counter (preambleTransMax). If no, then at operation 1015, RACH failure is indicated.

If yes, then at operation 1017, the preamble transmission counter is increased. Then at operation 1019, beam and SSB is changed for next preamble transmission. In a first method, next power level for preamble transmission is independent of beam widths. Hence, there will not be any need to reset the ramping counter. In other words, if SSB remains the same, then power ramping counter will increase, at operation 1021. If the SSB chosen is different, then ramping counter will be reset to 1 at operation 1023, as this indicates using a different direction.

In a second method, different power operations can be defined for different beam widths and the power ramping counter is reset to 1 if beam width changes as well. This way, the initial RACH procedure is performed even if beams with different beamwidths have different beam gains and have different transmit power requirements for reliable reception at the receiver.

Then, at operation 1019, it is checked if any SSB is left with different beamwidth. If yes, then at operation 1021, the preamble power ramping counter is increased and the method again moves to operation 1007. If no, then at operation 1023, the preamble power ramping counter is set to 1. This way, the initial RACH procedure is performed even if beams with different beamwidths have different beam gains and have different transmit power requirements for reliable reception at the receiver.

It is to be noted that the preamble power ramping counter shall be reset when different SSB or the SSB with different beam width is chosen for next preamble transmission or shall remain if same SSB is chosen with same beam width as that of the last preamble transmission. Also, the preamble transmission counter shall be incremented irrespective of the SSB beam width level chosen for preamble transmission.

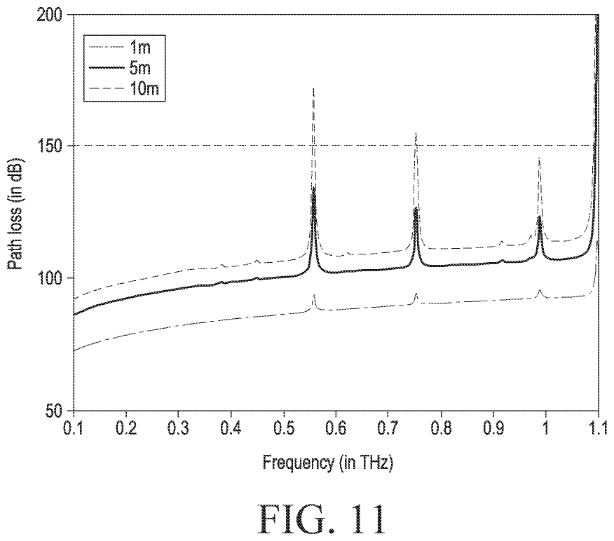

THz frequency experiences absorption noise which causes unwanted spikes in the path loss at certain frequencies with increasing distance, as shown in FIG. 11. From FIG. 11, it can be seen that at 0.55 THz, receiver at the UE, at 1 m has only path loss of ˜90 dB, whereas the receiver at 10 m distance will experience a path loss of 175 dB. Thus, distance aware communications and resource allocation based on the distance at which the receiver is located becomes necessary in THz. Also, the base station should be able to estimate the distance at which the UE is located and allocate the resources accordingly. Further, it is to be noted that the UE is one of the plurality of UEs to whom base station transmitted in operation 207. In an embodiment, a procedure for distance aware resource allocation for THz is discussed below.

Resource allocations for uplink and downlink are done at the base station when the UE requests for RACH with uplink data request and whenever there is a data to be transmitted to the UE in the downlink, respectively. The base station allocates the resources for uplink data once the RACH becomes successful and then indicates the uplink resources to the UE using the downlink control information (DCI) content in the PDCCH channel Similarly, the base station indicates the downlink resources to the UE through DCI while in connected mode or through paging message while in idle mode.

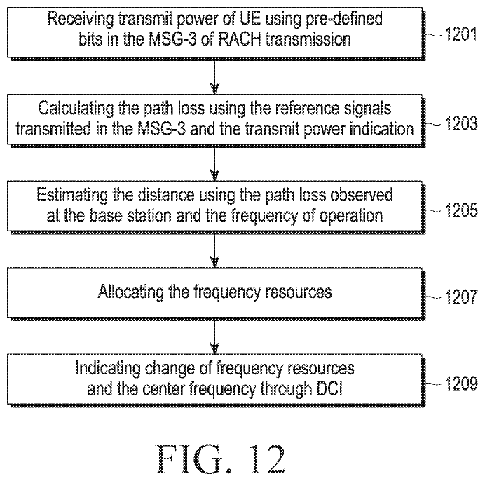

In an embodiment, the base station may determine distance at which the at least one UE is located and path loss experienced by the at least one UE. Thereafter, the base station may determine resources and center frequency for at least one of the plurality of UE based on at least one of the distance and the path loss. FIGS. 12 to 14 present different embodiments for resource allocation. It is to be noted that the base station may perform the methods as described in reference to FIGS. 12 to 14 using the first beam and/or plurality of second beams generated in accordance with techniques described in FIG. 2.

FIG. 12 illustrates a flow chart depicting a process for resource allocation in THz, according to an embodiment of the disclosure. Referring to FIG. 12, at operation 1201, a base station can receive transmit power of UE using pre-defined bits in the MSG-3 of RACH transmission or Physical Uplink Control Channel/Physical uplink shared channel (PUCCH/PUSCH). It is to be noted that the number of bits ‘N’ may vary for different UEs. At operation 1203, the base station may calculate the path loss using the reference signals transmitted in the MSG-3 and the transmit power indication. At operation 1205, the base station may estimate the distance using the path loss observed at the base station and the frequency of operation with the help of path loss curve for each humidity level. The humidity level can be determined using a humidity sensor or hygrometer at the base station. At operation 1207, based on the distance estimated, the base station can allocate the frequency resources (i.e., center frequency and/or bandwidth) to the UE avoiding high path loss frequencies. At operation 1209, the base station can indicate the change of frequency resources and the center frequency through downlink control information (DCI). This method is helpful for allocating resources for uplink or the following downlink transmissions when RACH is initiated for uplink data transmission request.

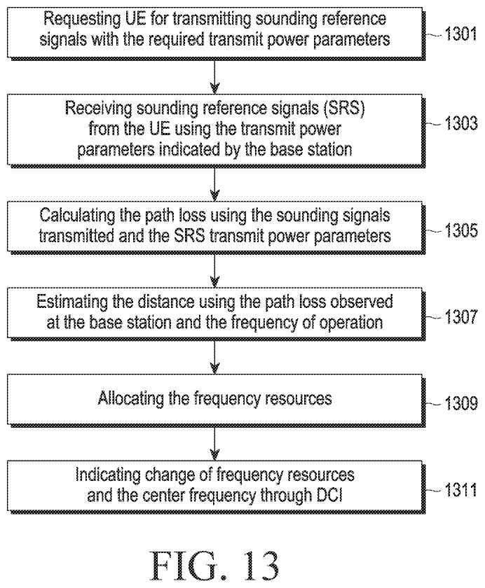

FIG. 13 illustrates a flow chart depicting a process for resource allocation in THz, according to an embodiment of the disclosure. Referring to FIG. 13, at operation 1301, the base station requests the UE for transmitting sounding reference signals with the required transmit power parameters indicated through RRC and the DCI. At operation 1303, the base station may receive sounding reference signals (SRS) from the UE using the transmit power parameters indicated by the base station. At operation 1305, the base station may calculate the path loss using the sounding signals transmitted and the SRS transmit power parameters that are indicated to the UE by the base station. At operation 1307, the base station may estimate the distance using the path loss observed at the base station and the frequency of operation with the help of path loss curve for each humidity level. Humidity level can be determined using a humidity sensor or hygrometer at the base station. At operation 1309, based on the distance estimated, the base station can allocate the frequency resources (i.e., center frequency and/or bandwidth) to the UE avoiding high path loss frequencies. At operation 1311, the base station can indicate the change of frequency resources and the center frequency through downlink control information (DCI). This method is helpful for allocating resources for uplink or downlink using the sounding reference signals. The periodicity of this method of allocating resources can be adjusted by the base station as per the user movement. Further, along with the bandwidth change, the base station may also indicate the center frequency change (if required) through the DCI in THz system, which is beneficial for users supporting limited bandwidth and their current center frequency falls under high path loss frequency.

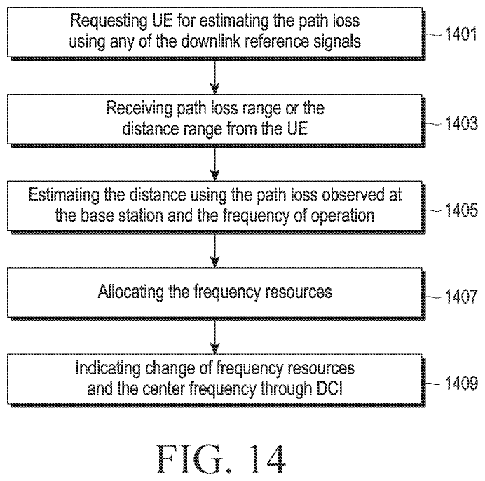

FIG. 14 illustrates a flow chart depicting a process for resource allocation in THz, according to an embodiment of the disclosure. Referring to FIG. 14, at operation 1401, the base station requests the UE for estimating the path loss using any of the downlink reference signals such as SSB or Channel State Information Reference Signal (CSI-RS), indicating their transmit power.

In an embodiment, the UE ay estimate the path loss using the configured reference signal and the transmit power parameters indicated by the base station. At operation 1403, the base station may receive the path loss range or the distance range from the UE, wherein the UE incorporates the path loss information or the distance range in the uplink control information transmitted either using PUCCH/PUSCH. In an embodiment, a pre-defined N number of bits may be identified in (PUCCH/PUSCH) for indicating the path loss information. It is to be noted that the number of bits ‘N’ may vary for different UEs.

At operation 1405, the base station may estimate the distance using the path loss observed at the base station and the frequency of operation with the help of path loss curve for each humidity level. Humidity level can be determined using a humidity sensor or hygrometer at the base station. However, if the distance is indicated directly by the UE, the base station can use the distance for identifying the frequency resources. At operation 1407, based on the distance estimated, the base station can allocate the frequency resources (i.e., center frequency and/or bandwidth) to the UE avoiding high path loss frequencies. At operation 1409, the base station can indicate the change of frequency resources and the center frequency through downlink control information (DCI). This method is helpful when the UE cannot share the transmit power parameters with the base station, but has a provision for sharing the path loss or the distance range values with the base station.

Further, it shall be noted that the methods discussed in reference to FIGS. 12 to 14 shall also support the center frequency change indication through DCI to support the low bandwidth UEs.

Due to the high frequency of operation, THz gets severely affected by the blockages which may cause frequent beam blockages and beam failures. This can result in frequent beam recovery procedures in THz. In such scenario, to re-connect to the base station, UE can perform a RACH procedure for beam failure recovery with new candidate beams after the beam failure is detected. Dedicated RACH resources can be allocated for beam failure recovery as part of RRC configuration BeamFailureRecoveryConfig.

However, with multiple narrow beams possible in THz, UE can have more than one candidate beams whose RSRP exceeds the threshold for RACH threshold. Also, if the UE is in mobility, the RSRP observed with each of these candidate beams can keep on changing. In such cases, to make sure that the right candidate beam is chosen for beam failure recovery and also to decrease the latency in recovery, the disclosure discloses a method for beam failure recovery which supports multiple such RACH occasions for beam failure recovery, which can come as a part of dedicated RACH configuration, possible to be transmitted with different candidate beams. Further, the multiple RACH transmissions can also be transmitted with same candidate beam which increases the probability of the RACH success in less time.

In an embodiment, multiple RACH occasions are introduced for beam failure recovery in THz, for faster recovery. These RACH occasions can be multiplexed in time domain with same or different candidate beams crossing the threshold.

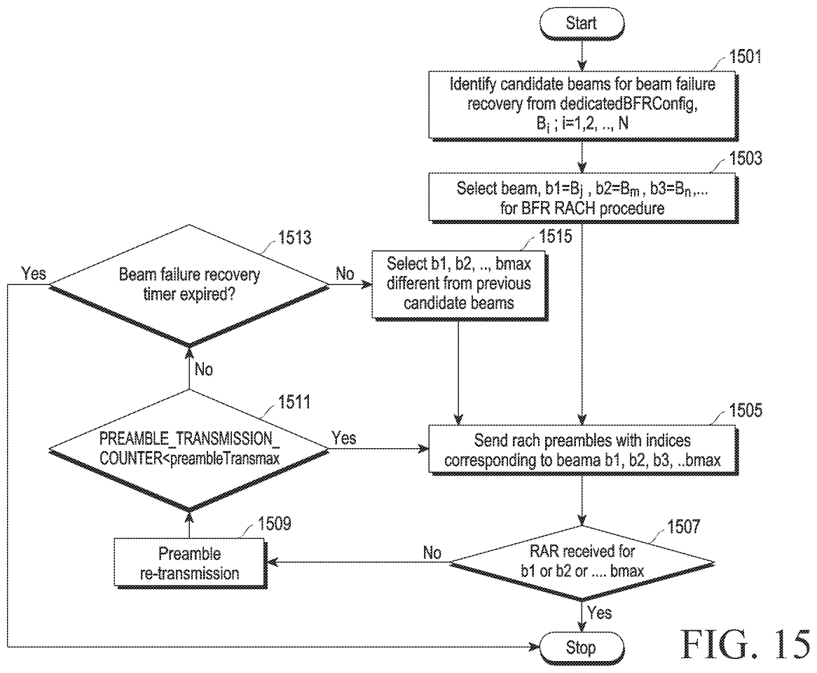

FIG. 15 illustrates a flow chart depicting a process for beam failure recovery in THz, according to an embodiment of the disclosure. Referring to FIG. 15, at operations 1501 and 1503, at least one beam is identified for beam failure recovery through multiple random-access channel (RACH) occasions. Then, at operation 1505, multiple RACH preambles are transmitted in time division manner with indices corresponding to the identified using at least one beam. Then at operation 1507, it is determined if RAR is received from the at least one beam. If yes, then the process stops. If not, operations 1501 to 1507 are repeated for a maximum number ‘N’ of simultaneous RACH transmissions until the RAR is received from the at least one beam. In particular, then at operation 1509, the preamble is retransmitted. At operation 1511, it is determined if the preamble transmission counter is less than preamble maximum transmission counter (i. e., PREAMBLE_TRANSMISSION_COUNTER<preambleTransMax). If yes, then the method moves to operation 1505. If no, then it is checked if beam failure recovery timer is expired. If yes, then the method stops. If not, then a beam is identified for beam failure from different candidate beams.

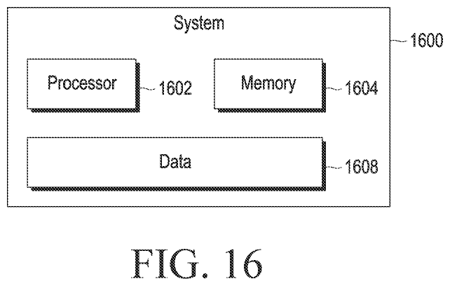

FIG. 16 illustrates a block diagram of a system for communication in a high frequency network base station, according to an embodiment of the disclosure. The system 1600 may include, but is not limited to, a processor 1602, memory 1604, and data 1608. The memory 1604 may be coupled to the processor 1602. In an embodiment, the processor 1602 may be configured to generate a first beam having a first beamwidth in a first area of a cell, determine a plurality of second beamwidth levels for each of a plurality of second beams possible in the first beamwidth of the first beam, wherein a second beamwidth is narrower than the first beamwidth, generate the plurality of second d beams having the plurality of second beamwidth levels based on the determination, and transmit at least one synchronization message to a plurality of user equipment via the first beam and the plurality of second beams. In an embodiment, the system 1600 may be configured to perform the method as discussed in respect to FIGS. 2 through 15. Further, the system 1600 may be a part of the base station. In another embodiment, the system 1600 may be connected to the base station.

The processor 1602 can be a single processing unit or several units, all of which could include multiple computing units. The processor 1602 may be implemented as one or more microprocessors, microcomputers, microcontrollers, digital signal processors, central processing units, state machines, logic circuitries, and/or any devices that manipulate signals based on operational instructions. Among other capabilities, the processor 1602 is configured to fetch and execute computer-readable instructions and data stored in the memory 1604.

The memory 1604 may include any non-transitory computer-readable medium including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The data 1608 serves, amongst other things, as a repository for storing data processed, received, and generated by the processor 1602.

Hence, the disclosure identifies the protocol changes required for implementing 6G-THz system in compatibility with the existing 5G NR system. In particular, the disclosure discloses techniques for sequencing for hierarchical beams, which is very crucial for THz system, where hierarchical beams in a direction with different beamwidths are transmitted consecutively, which helps in combining the beams efficiently at the receiver increasing the overall Signal-Noise Ratio (SNR) observed at the receiver and also help in increasing the cell coverage for THz system. However, it is to be noted that there can be further implementation specific fundamental solutions to overcome the high propagation loss such as increased transmit power, using repeaters or repeated transmissions, more number of antennas for increased antenna gain, which could be identified during the standardization of THz system.

Also, following advantages are provided by the disclosed techniques:

SSB transmit beam sequencing in THz system allows combining across multiple beamwidths which improves the cell coverage and the observed SNR at the receiver, and also reduces the cell search time because of this.

Further, same SSB burst period for THz system may be used which was used in 5G NR i.e., 5 ms to maintain the compatibility. For example, with 120 KHz subcarrier spacing, a total of 40 slots are available within SSB burst of 5 ms, out of which 32 slots are only used to transmit 64 SSBs in current 5G NR system. However, using the disclosed techniques, with 40 slots, a maximum of 80 SSBs may be transmitted without adding any delay. Also, as the subcarrier spacing is increased, the number of slots within SSB burst shall increase, making it feasible to transmit more SSBs within an SSB burst, i.e., 160 SSBs in 80 slots for 240 KHz subcarrier spacing (SCS). Thus, higher subcarrier spacing can be used to transmit more number of beams without causing any delay.

While specific language has been used to describe the disclosure, any limitations arising on account of the same are not intended. As would be apparent to a person in the art, various working modifications may be made to the method in order to implement the inventive concept as taught herein.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein.

Moreover, the actions of any flow diagram need not be implemented in the order shown, nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for communication by a base station in a high frequency network, the method comprising:
generating a first beam having a first beamwidth in a first area of a cell;
determining a plurality of second beamwidth levels for a plurality of second beams possible in the first beamwidth of the first beam, wherein a second beamwidth associated with each of the plurality of second beams is narrower than the first beamwidth;
generating the plurality of second beams having the determined plurality of second beamwidth levels; and
transmitting at least one synchronization message to a plurality of user equipments (UEs) via the first beam and the plurality of second beams.

2. The method of claim 1, wherein the first beamwidth is a required for maximum coverage in the first area of the cell.

3. The method of claim 1, wherein the first beam is generated subsequent to determining the first area.

4. The method of claim 1, further comprising:
receiving a response to the at least one synchronization message from at least one user equipment, amongst the plurality of user equipment, over one of the first beam or the plurality of second beams; and
establishing a connection with the at least one user equipment over one of the first beam or the plurality of second beams.

5. The method of claim 1, further comprising:
transmitting the at least one synchronization message via the first beam and the plurality of second beams in frequency domain,
wherein the at least one synchronization message with the first beam and the plurality of second beams is transmitted periodically.

6. The method of claim 1,
wherein the transmitting of the at least one synchronization message comprises:
multiplexing the first beam and the plurality of second beams in time domain, and
wherein a sequencing of the first beam and the plurality of second beams respectively is done such that the first beam and at least one of the plurality of second beams in a same direction are multiplexed consecutively in the time domain.

7. The method of claim 1,
wherein the transmitting of the at least one synchronization message comprises:
multiplexing the first beam and the plurality of second beams in time domain, and
wherein a sequencing of the first beam and the plurality of second beams with the first and second beamwidths respectively is done using either method such that a number of beams in the second beamwidth can be a multiple of the number of beams with maximum beamwidth or the number of beams in all beamwidths are generated independent of each other.

8. The method of claim 1, wherein the at least one synchronization message is transmitted via the first beam and the plurality of second beams during an initial access procedure.

9. The method of claim 1, further comprising:
allowing or disabling transmission of at least one synchronization message via the first beam and the plurality of second beams using a bit map;
indicating the allowing or disabling to a receiver through higher layer, radio resource control (RRC) reconfiguration message, physical downlink control channel (PDCCH), or medium access control (MAC) Control Element (MAC CE); and
indicating transmit power of a beam with one beamwidth and offsets for other beamwidth levels through either a broadcast message, master information block (MIB), or the RRC reconfiguration message.

10. The method of claim 1, further comprising:
associating a plurality of synchronization signal blocks (SSBs) with different first and second beam widths, in a same direction to a same radio access channel (RACH) occasions when the plurality of SSBs are associated with single RACH occasion; and
receiving radio access channel (RACH) preambles on radio access channel (RACH) occasions corresponding to a second beamwidth level when the at least one synchronization message is above a predetermined threshold,
wherein a power ramping counter is incremented using a transmit power offset indicated when at least one UE changes the SSBs with different beam widths.

11. The method of claim 1, further comprising:
determining distance at which at least one UE among the plurality of UEs, is located and path loss experienced by the at least one UE; and
determining resources and center frequency for at least one of the plurality of UEs based on at least one of the distance or the path loss.

12. The method of claim 11, wherein the determining of the path loss comprises:
receiving transmit power of the at least one UE using pre-defined N number of bits either through a message-3 (MSG-3) or physical uplink control channel/physical uplink shared channel (PUCCH/PUSCH), and determining the path loss based on the received transmit power; or
receiving the path loss using second pre-defined N number of bits through physical uplink control channel or physical uplink shared channel (PUCCH/PUSCH).

13. The method of claim 11, wherein the determining of the distance comprises receiving the distance using pre-defined N number of bits through physical uplink control channel or physical uplink shared channel (PUCCH/PUSCH).

14. The method of claim 11, further comprising:
indicating change of frequency resources and the center frequency through a downlink control information (DCI).

15. The method of claim 11, wherein the determining of the distance is based on at least one of a frequency of operation or a path loss curve for each humidity level.

16. The method of claim 1, further comprising:
identifying at least one beam for beam failure recovery through multiple random-access channel (RACH) occasions;
transmitting multiple RACH preambles in time division manner with indices corresponding to the identified at least one beam;
determining if random access response (RAR) is received from the at least one beam; and
repeating operations a to c for a maximum number ‘N’ of simultaneous RACH transmissions until the RAR is received from the at least one beam.

17. The method of claim 16, further comprising:
receiving RACH messages using different beams upon detection of beam failure.

18. The method of claim 16, further comprising:
indicating a best candidate beam through a medium access control (MAC) control element (MAC CE) or a downlink control information (DCI) after receiving multiple RACH messages from at least one UE among the plurality of UEs.

19. The method of claim 16, further comprising:
indicating maximum number of multiple RACH transmissions through RRC reconfig message via at least one of the following information elements: BeamFailureRecoveryConfig, RACH Config Common, or RACH Config dedicated.

20. A base station for communication in a high frequency network, the base station comprising:
a memory; and
a processor coupled to the memory and configured to:
generate a first beam having a first beamwidth in a first area of a cell,
determine a plurality of second beamwidth levels for a plurality of second beams possible in the first beamwidth of the first beam, wherein a second beamwidth associated with each of the plurality of second beams is narrower than the first beamwidth,
generate the plurality of second beams having the determined plurality of second beamwidth levels, and
transmit at least one synchronization message to a plurality of user equipments (UEs) via the first beam and the plurality of second beams.
